(19) United States
(12) Patent Application Publication
(10) Pub. No.: US 2016/0283030 A1
(43) Pub. Date: Sep. 29, 2016

(54) Electronic Device, Wearable Device and Controlling Method Thereof

(71) Applicant: Samsung Electronics Co., Ltd., Suwon-si (KR)

(72) Inventors: Seol-hye WON, Seoul (KR); Sun-ho MOON, Suwon-si (KR); Pil-seung YANG, Suwon-si (KR); Jin-young LEE, Suwon-si (KR)

(21) Appl. No.: 15/079,983

(22) Filed: Mar. 24, 2016

(30) Foreign Application Priority Data
Mar. 27, 2015 (KR) 10-2015-0043398

(51) Int. Cl. G06F 3/041; G06F 1/16; H04B 5/00; G06F 3/14

(52) U.S. Cl. CPC G06F 3/0416; G06F 3/1431; G06F 1/163; H04B 5/0031; H04W 84/12

(57) ABSTRACT

An electronic device, a wearable device, and a controlling method thereof are provided. The method of controlling an electronic device according to an exemplary embodiment includes receiving a touch command with respect to an object displayed on a display screen, generating an inductive current based on a signal pattern corresponding the object for which the touch command is received and the electronic device, and transmitting the inductive current generated to a wearable device through a user who touches the object. Accordingly, an exemplary embodiment may minimize or reduce procedures for user authentication at a terminal or a service.

### RELATED APPLICATION(S)

This application claims priority from Korean Patent Application No. 10-2015-0043398, filed in the Korean Intellectual Property Office on Mar. 27, 2015, the disclosure of which is incorporated herein by reference.

### BACKGROUND

Aspects of the exemplary embodiments relate to an electronic device, a wearable device, and a controlling method thereof.

With the development of communication technologies and electronic devices, a user may use various contents and applications more easily and quickly.

However, whenever a user wishes to execute an application or a content, or connect to a web page screen using his or her display apparatus, the user needs to perform authentication through a complicated authentication process and should endure inconvenience as the user authentication should be performed for each execution.

In addition, a user has to memorize user information that he or she has set for each of the various contents and applications, causing further inconvenience to the user.

### SUMMARY

An aspect of the exemplary embodiments is to minimize or reduce user authentication steps or procedures which may authenticate a user for a terminal or a service.

According to an exemplary embodiment, there is provided a method of controlling an electronic device including receiving a touch command with respect to an object displayed on a display screen, generating an inductive current based on a signal pattern corresponding the object for which the touch command is received and the electronic device, and transmitting the inductive current generated to a wearable device through a user who touches the object.

The inductive current may be a micro-current signal with a frequency component.

The generating may include, in response to an object corresponding to the touch command being detected, acquiring a signal pattern corresponding to the object detected and a signal pattern corresponding to address information of the electronic device from among pre-stored signal patterns, and generating an inductive current with a frequency component corresponding to the signal patterns acquired.

The generating may include generating a signal pattern corresponding to token information for pairing with the wearable device, and generating the inductive current with the frequency component corresponding to the signal pattern generated.

The method may further include, in response to user information being received from the wearable device, executing a function corresponding to the object touched based on the user information received.

According to an exemplary embodiment, there is provided a method of controlling a wearable device including receiving an inductive current generated from an external device through a user who touches a display screen of the external device, extracting service information regarding an object touched by the user from among objects displayed on the display screen and address information regarding the external device by analyzing the inductive current received, and transmitting user information corresponding to the service information to the external device based on the address information.

The inductive current may be a micro-current signal with a frequency component.

The extracting may include detecting a signal pattern from the frequency component included in the inductive current, and extracting service information regarding an object touched by the user and address information regarding the external device by analyzing the detected signal pattern.

The extracting may further include extracting token information for pairing with the external device from a signal pattern detected from the frequency component included in the inductive current, and the transmitting may include transmitting user information included in the token information to the external device.

The method may further include, in response to predefined code information being extracted from the detected signal pattern, storing the service information and the address information regarding an object touched by the user, and in response to service information being selected from among a plurality of pieces of pre-stored service information, displaying information regarding the object based on the address information which is associated with the service information and pre-stored.

According to an exemplary embodiment, there is provided an electronic device including a touch input unit configured to receive a touch command with respect to an object displayed on a display screen, and a controller configured to generate an inductive current based on a signal pattern corresponding to the object for which the touch command is received and the electronic device, and the inductive current is transmitted to a wearable device through a user who touches the object.

The inductive current may be a micro-current signal with a frequency component.

The controller, in response to an object corresponding to the touch command being detected, may acquire a signal pattern corresponding to the object detected and a signal pattern corresponding to address information of the electronic device from among pre-stored signal patterns, and generate an inductive current with a frequency component corresponding to the acquired signal patterns.

The controller may generate a signal pattern for pairing with the wearable device, and generate an inductive current with the frequency component corresponding to the signal pattern generated for pairing.

The electronic device may further include a communicator, and the controller, in response to user information being received from the wearable device, may execute a function corresponding to the object touched based on the user information received.

According to an exemplary embodiment, there is provided a wearable device including a receiver configured to receive an inductive current generated from an external device through a user who touches a display screen of the external device, a communicator configured to perform data communication with the external device, and a controller configured to extract service information regarding an object touched by the user from among objects displayed on the screen and address information regarding the external device by analyzing the inductive current received, and control the communicator to transmit user information corresponding to the service information to the external device based on the address information.

The inductive current may be a micro-current signal with a frequency component.

The controller may detect a signal pattern from the frequency component included in the inductive current, and extract service information regarding an object touched by the user and address information regarding the external device by analyzing the signal pattern detected.

The controller may further acquire token information for pairing with the external device from a signal pattern detected from the frequency component included in the inductive current, and control the communicator to transmit user information including the token information to the external device.

The wearable device may further include a storage and a display, and the controller, in response to predefined code information being acquired from the signal pattern detected, may store the service information and the address information regarding an object touched, and in response to a command to select service information from among a plurality of pieces of service information pre-stored in the storage being input, control the display to display information regarding the object received from the external device based on address information related to the service information for which the selection command is input.

As described above, according to the various exemplary embodiments, the present disclosure may minimize or reduce procedures for user authentication.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is a schematic block diagram illustrating configuration of a system which performs recognition between user devices according to an exemplary embodiment;

FIG. 2 is a process view of a system which performs recognition between user devices according to an exemplary embodiment;

FIG. 3 is a block diagram of an electronic device according to an exemplary embodiment;

FIG. 4 is a detailed block diagram of an electronic device according to an exemplary embodiment;

FIG. 5 is a block diagram of a wearable device according to an exemplary embodiment;

FIG. 6 is an exemplary view where an electronic device generates an inductive current according to an exemplary embodiment;

FIG. 7 is a first exemplary view where data communication is performed between an electronic device and a wearable device according to an exemplary embodiment;

FIG. 8 is a second exemplary view where data communication is performed between an electronic device and a wearable device according to another exemplary embodiment;

FIG. 9 is a third exemplary view where data communication is performed between an electronic device and a wearable device according to another exemplary embodiment;

FIG. 10 is a fourth exemplary view where data communication is performed between an electronic device and a wearable device according to another exemplary embodiment;

FIG. 11 is a fifth exemplary view where data communication is performed between an electronic device and a wearable device according to another exemplary embodiment;

FIG. 12 is a flowchart regarding a method of controlling an electronic device according to an exemplary embodiment;

FIG. 13 is a flowchart regarding a method of controlling a wearable device according to an exemplary embodiment; and

FIG. 14 is a process view where data communication between an electronic device and a wearable device is performed through a server according to another exemplary embodiment.

### DETAILED DESCRIPTION

The terms “first,” “second,” etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, exemplary embodiments of the present disclosure will be described in detail with reference to the accompanying drawings.

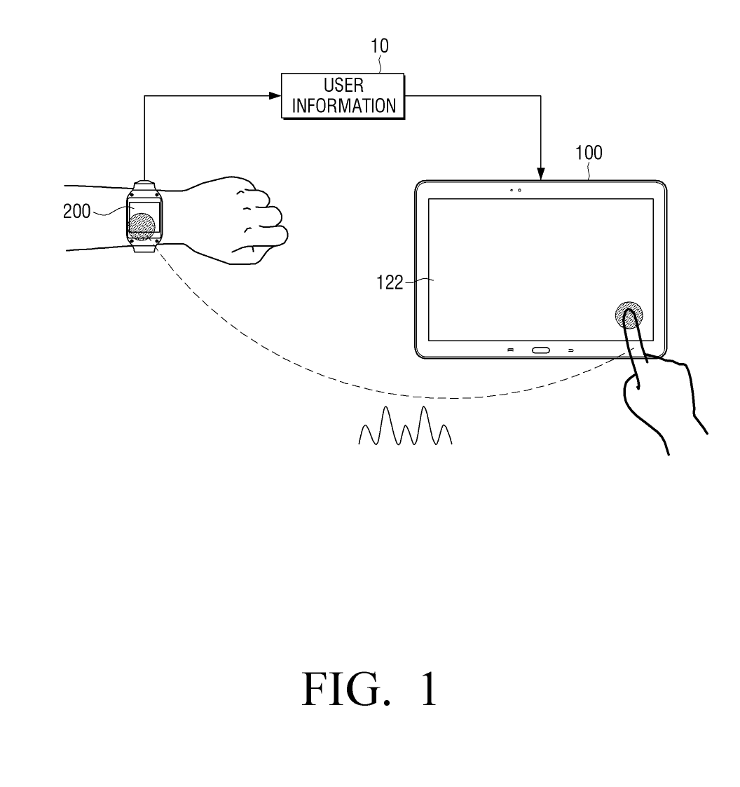

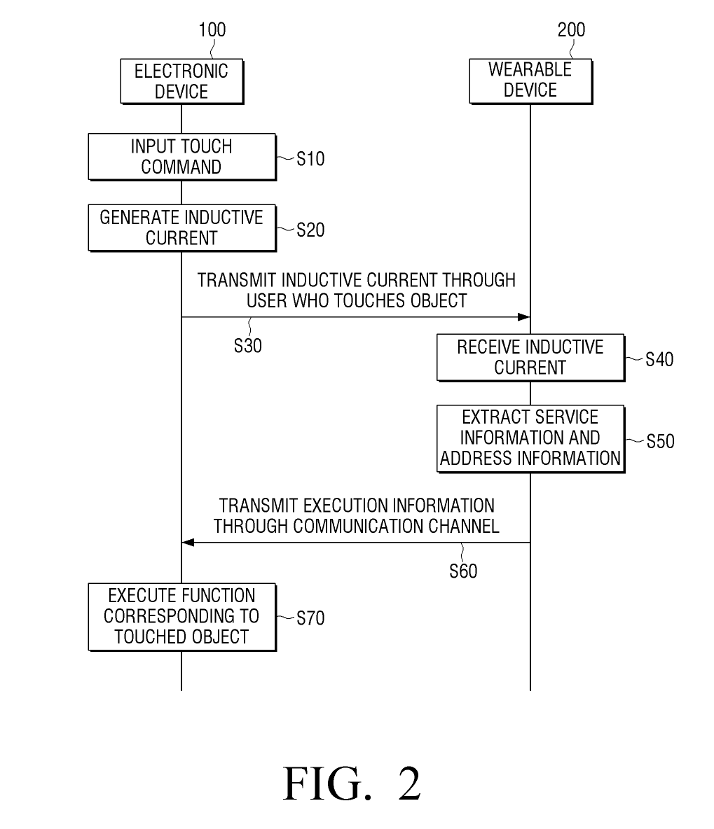

FIG. 1 is a schematic block diagram illustrating configuration of a system which performs recognition between user devices according to an exemplary embodiment, and FIG. 2 is a process view of a system which performs recognition between user devices according to an exemplary embodiment.

As illustrated in FIG. 1, a system which performs recognition between user devices including an electronic device 100 and a wearable device 200.

Both the electronic device 100 and the wearable device 200 may perform data communication with a peripheral terminal device wirelessly, and display contents. The electronic device 100 may be a user terminal device capable of performing a touch input, such as a smart phone, a tablet personal computer (PC), a kiosk, etc., and the wearable device 200 may be a device which is wearable on a part of a user body, such as a smart watch, an electronic glasses, etc. However, an exemplary embodiment is not limited thereto, and the wearable device 200 may be a user terminal device such as a smart phone, a tablet PC, etc.

Specifically, as illustrated in FIG. 2, if a user wearing the wearable device 200 touches an area of a display screen 122 of the electronic device 100, the electronic device 100 receives a touch command corresponding to the touch on the area of the display screen 122 at block S10. When the touch command is input or received, the electronic device 100 generates an inductive current based on a signal pattern regarding the object which is touched by a user on the display screen 122 and the electronic device 100 at block S20. Specifically, if a touch command regarding one object displayed on a display screen of the electronic device 100 is input, the electronic device 100 acquires a signal pattern which is predetermined with respect to an object for which the touch command is input and a signal pattern which is predetermined with respect to address information. Here, each of the signal patterns which are predetermined with respect to the object and the address information of the electronic device 100 may be a binary signal pattern.

Accordingly, if the signal patterns corresponding to each of the predetermined binary signals regarding the object and the address information of the electronic device 100 are acquired, the electronic device 100 may generate an inductive current based on the signal patterns acquired. For example, a predetermined signal pattern with respect to an object corresponding to a user's touch command may be ‘10,’ and a predetermined signal pattern with respect to address information of the electronic device 100 may be ‘001 010 . . . ’ In this case, the electronic device 100 may generate an inductive current with a first frequency component of 100 KHz and 90 KHz based on a predetermined signal pattern with respect to the object by a predetermined time unit and a second frequency component of 90 KHz, 90 KHz, 100 KHz, 90 KHz, 100 KHz, and 90 KHz . . . based on a predetermined signal pattern with respect to the address information of the electronic device 100.

In this case, the electronic device 100 may generate an inductive current including an ACK signal to identify not only the first and second frequency components but also whether the first frequency component or the second frequency component is started or finished and a third frequency component corresponding to a signal pattern for pairing with a wearable device. When such an inductive current is generated, the electronic device 100 transmits the inductive current to the wearable device 200, which a user is wearing, through the user who touches the object at block S30.

The wearable device 200 which receives the inductive current through the user analyzes the inductive current and extracts service information regarding the object touched by the user and address information regarding the electronic device 100 at blocks S40, S50. Specifically, the wearable device 200 detects a signal pattern representing the object corresponding to the user's touch command and address information of the electronic device 100 from the first and second frequency components included in the inductive current received. In this case, the wearable device 200 may further detect a signal pattern representing token information for pairing with the electronic device 100 from the third frequency component included in the inductive current received. When such a signal pattern is detected, the wearable device 200 detects service information regarding the object touched by the user, address information regarding the electronic device 100, and token information for pairing based on the signal pattern detected.

Subsequently, the wearable device 200 transmits execution information including user information corresponding to the service information and the token information to the electronic device 100 through a communication channel corresponding to a communication module capable of performing wireless communication based on pre-extracted address information at block S60. When the execution information is received from the wearable device 200 through the corresponding communication channel, the electronic device 100 performs pairing with the wearable device 200 based on the token information included in the execution information received, and, executes a function corresponding to the object touched by the user based on the user information included in the execution information at block S70.

Accordingly, the user does not have to further input additional user information, such as user authentication information, at the electronic device 100 for executing an object displayed on the electronic device 100, and thereby reducing user inconvenience.

Hereinafter, configuration of each of the electronic device 100 and the wearable device 200 will be described in detail.

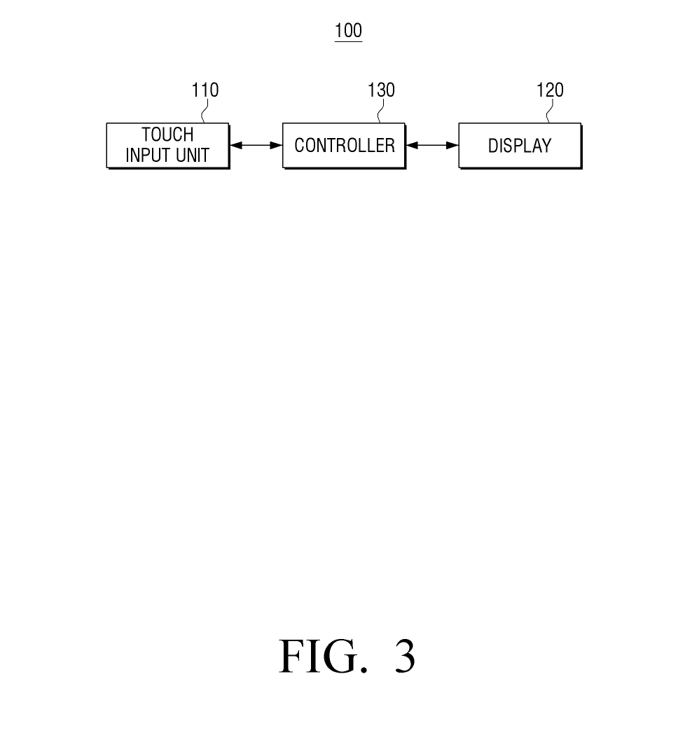

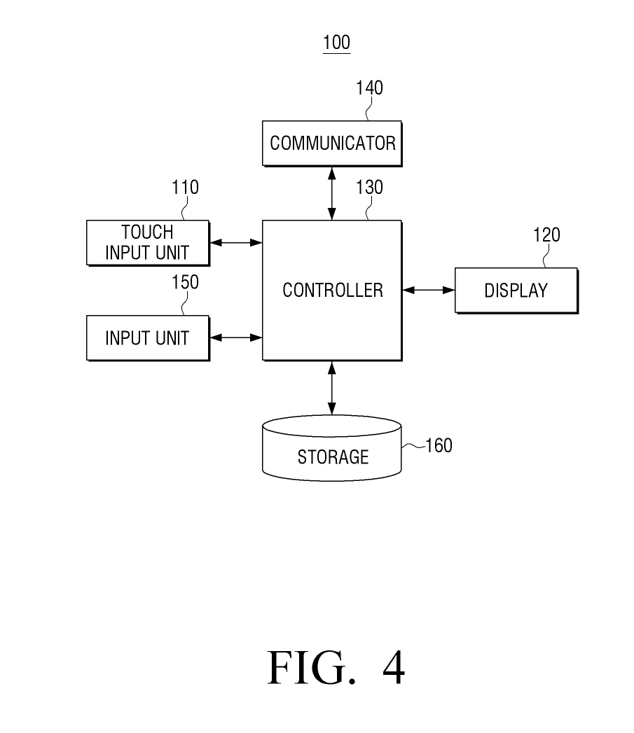

FIG. 3 is a block diagram of an electronic device 100 according to an exemplary embodiment, and FIG. 4 is a detailed block diagram of an electronic device according to an exemplary embodiment.

As illustrated in FIG. 3, the electronic device 100 includes a touch input unit 110, a display 120 (e.g., the display screen 122 of FIG. 2) and a controller 130.

The touch input unit 110 receives a touch command with respect to an object displayed on a display screen. The touch input unit 110 may be a touch panel (not shown) formed on an upper surface of the display 120. Specifically, if the change of electric current is detected according to a user touch with respect to the touch panel (not shown) through a touch sensor (not shown) which uses a capacitance method, the touch input unit 110 transmits a detection signal regarding the change of electric current detected through the touch sensor (not shown) to the controller 130. Accordingly, the controller 130 acquires a coordinates of the area where the flow of electric current is changed based on the detection signal transmitted from the touch input unit 110 and determined that an object corresponding to the acquired coordinates as the object touched by the user.

The display 120 displays data and contents which are processed according to a control command of the controller 130, and may be embodied to be integrated with a touch panel (not shown) to receive a user's touch command. Accordingly, the display 120 may not only display various data and contents which are processed according to a control command of the controller 130 on a screen (e.g., the display screen 122) but also receive a user's touch command through a touch panel (not shown).

The controller 130 controls the overall operations of each element of the electronic device 100. In particular, the controller 130 generates an inductive current based on a signal pattern corresponding to each of the object for which a user's touch command is input through the touch input unit 110 and the electronic device 100. The inductive current is micro-current with a frequency component, and is transmitted to a wearable device which the user wears on part of his or her body through the user who touches the object.

Specifically, if an object corresponding to a touch command is detected from among a plurality of pieces of objects included in a content which is displayed through the display 120, the controller 130 obtains a signal pattern corresponding to the pre-detected object and a signal pattern corresponding to the address information of the electronic device 100 from among pre-stored signal patterns. Subsequently, the controller 130 generates the inductive current with frequency components corresponding to each of the signal pattern corresponding to the object and the signal pattern corresponding to the address information of the electronic device.

For example, a predetermined signal pattern with respect to an object corresponding to a user's touch command may be ‘10,’ and a predetermined signal pattern with respect to address information of the electronic device 100 may be ‘001 010 . . . ’ In this case, the controller 130 may generate the inductive current with a first frequency component of 100 KHz and 90 KHz based on a predetermined signal pattern with respect to the object by a predetermined time unit and a second frequency component of 90 KHz, 90 KHz, 100 KHz, 90 KHz, 100 KHz, and 90 KHz . . . based on a predetermined signal pattern with respect to the address information of the electronic device 100.

According to another exemplary embodiment, the controller 130 may generate a signal pattern for pairing with the wearable device 200, and generate an inductive current that includes a frequency component corresponding to a signal pattern for pairing. In addition, the controller 130 may generate an inductive current having an ACK signal to identify whether the first component regarding the object, the second frequency component regarding the address information of the electronic device 100 and the frequency component regarding pairing is started or finished, respectively.

When such an inductive current is generated, the inductive current may be transmitted to the wearable device 200 which a user wears on part of his or her body through the user who touches the display 120 of the electronic device 100.

Meanwhile, as illustrated in FIG. 4, the electronic device 100 may further include a communicator 140, an input unit 150 and a storage 160 in addition to the touch input unit 110, the display 120 and the controller 130.

The communicator 140 performs data communication with a peripheral terminal device which is on the same network wirelessly. Here, the peripheral terminal device may be a wearable device, a smart phone, a tablet PC, a smart TV, etc. which transmits the inductive current through a user.

The communicator 140 may include various communication modules such as a near-field wireless communication module (not shown), a wireless communication module (not shown), etc. Here, the near-field wireless communication module performs near-field communication wirelessly with the electronic device 100 and a peripheral terminal device, and may be realized as at least one of a Bluetooth module, an infrared data association (IrDA) module, a Near Field Communication (NFC) module, a Wi-Fi module, a Zigbee module, etc. The wireless communication module is connected to an external network according to a wireless communication protocol such as Wi-Fi, IEEE, etc. and performs communication. In addition, the wireless communication module may further include a mobile communication module which is connected to a mobile communication network according to various mobile communication standards such as 3^{rd} Generation (3G), 3^{rd} Generation Partnership Project (3GPP), Long Term Evolution (LTE), etc. and performs communication.

The input unit 150 receives a user command from an input means such as a manipulator (not shown) provided on the electronic device 100. Accordingly, the controller 130 may control the operations of the electronic device 100 based on a user command input through the input unit 150 or display a content corresponding to the user command.

The storage 160 is a storage medium where various programs necessary to operate the electronic device 100 are stored, and may be embodied as a memory, a Hard Disk Drive (HDD), etc. For example, the storage 160 may include a Read Only Memory (ROM) which stores programs to perform the operations of the controller 130, a Random Access Memory (RAM) which stores data necessary to perform the operations of the controller 130 temporarily, etc. In addition, the storage 160 may further include Electrically Erasable and Programmable Read Only Memory (EEROM) which stores various reference data.

Further, the storage 160 may store identification code regarding each object, identification code regarding the address information of the electronic device 100, and token information for pairing with the wearable device 200.

Meanwhile, when execution information including user information is received from the wearable device 200 through the communicator 140, the controller 130 executes a function corresponding to an object touched by a user based on the user information received. Specifically, the execution information received from the wearable device 200 may include user information and token information to perform pairing with the wearable device 200. Accordingly, if the token information included in the received execution information is identical to the token information transmitted to the wearable device 200 through an inductive current, the controller 130 performs pairing with the wearable device 200. Subsequently, the controller 130 may perform a function corresponding to an object touched by a user based on the user information included in the execution information.

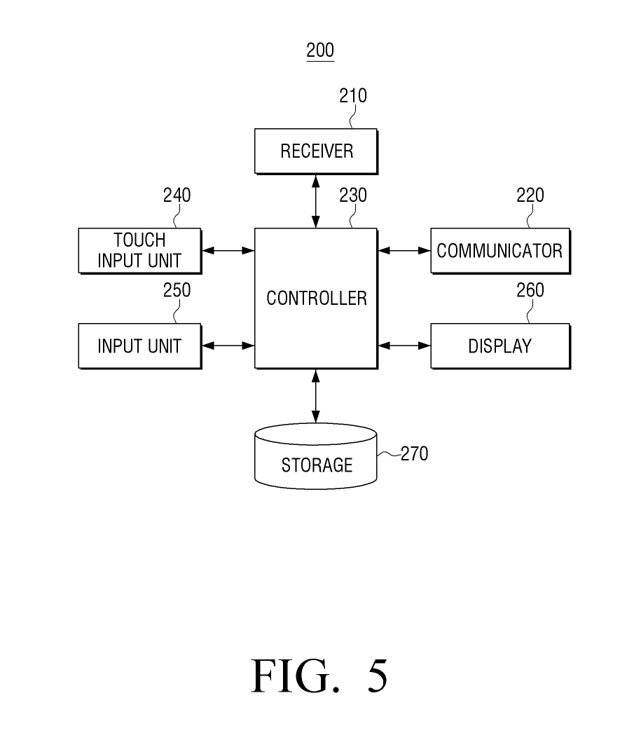

FIG. 5 is a block diagram of the wearable device 200 according to an exemplary embodiment.

As illustrated in FIG. 5, the wearable device 200 includes a receiver 210, a communicator 220, a controller 230, a touch input unit 240, an input unit 250, a display 260, and a storage 270.

Here, the configuration of the communicator 220, the touch input unit 240, the input unit 250, and the display 260 is the same as that of the electronic device 100, so the detailed description thereof will be omitted.

The receiver 210 receives an inductive current which is generated from the electronic device 100 through a user who touches a display screen of an external device (hereinafter, referred to as an electronic device). Here, the inductive current is micro-current with a frequency component, and may include a frequency component regarding an object touched by a user from among objects displayed on the display screen of the electronic device and a frequency component regarding the address information of the electronic device 100. In addition, the inductive current may further include a frequency component regarding token information for pairing with the electronic device 100 and an ACK signal to identify whether each frequency component is started or finished.

Once such an inductive current is received, the controller 230 analyzes the inductive current received to extract service information regarding an object touched by a user from among objects displayed on the display screen, address information of the electronic device 100, and token information for pairing with the electronic device 100.

According to an exemplary embodiment, the controller 230 detects a signal pattern corresponding to the object, the address information of the electronic device 100 and the token information for pairing, respectively, from a frequency component included in the inductive current. Subsequently, the controller 230 may analyze each of the signal patterns detected to extract service information regarding the object touched by a user, address information of the electronic device 100, and token information for pairing with the electronic device 100.

Once such information is extracted, the controller 230 acquires user information corresponding to the service information regarding the corresponding object from among user information which is pre-stored in the storage 270. Subsequently, based on the address information extracted, the controller 230 controls the communicator 220 to transmit the user information corresponding to the service information regarding the corresponding object to the electronic device 100 or transmit execution information including the user information and the token information to the electronic device 100. Accordingly, the communicator 220 may transmit the user information or the execution information including the user information and the token information to the electronic device 100 through a communication channel which is capable of performing wireless communication.

Meanwhile, according to another exemplary embodiment, when predefined code information is acquired from a signal pattern detected, the controller 230 stores service information and address information regarding an object touched by a user in the storage 270. Subsequently, when a selection command regarding service information from among a plurality of pieces of service information which is pre-stored in the storage 270 is input, the controller 230 controls the display 260 to display detailed information regarding the object, which is received from the electronic device 100, based on address information related to the service information for which the selection command is input. Here, the address information related to the service information may be the electronic device 100 or a content server (not shown) which transmits the inductive current. Accordingly, the display 260 may display the information received from the electronic device 100 or a content server (not shown) on a screen (e.g., the display screen 122).

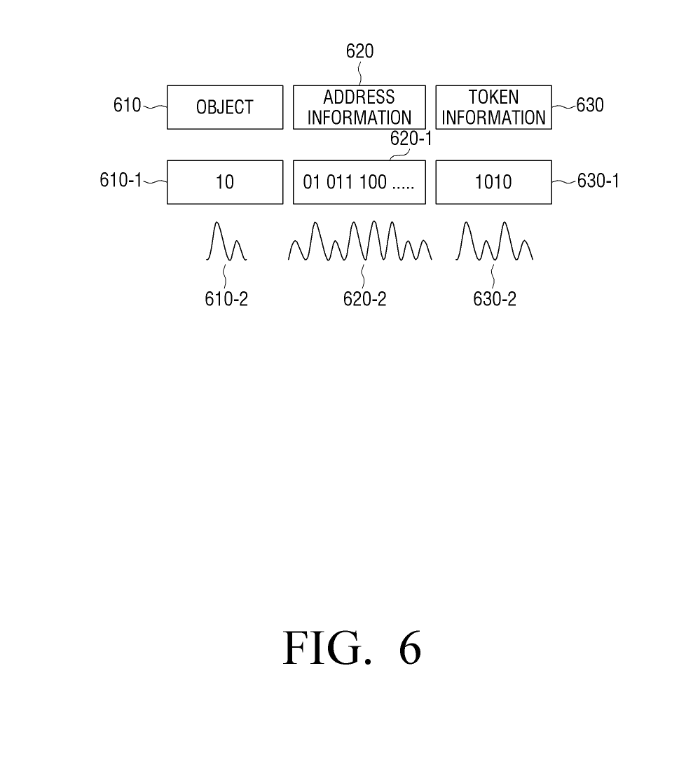

FIG. 6 is an exemplary view where an electronic device generates an inductive current according to an exemplary embodiment.

As illustrated in FIG. 6, when an object 610 corresponding to a user's touch command is detected, the electronic device 100 acquires a signal pattern 610-1 corresponding to the object 610 detected and a signal pattern 620-1 corresponding to address information 620 of the electronic device 100 from among pre-stored signal patterns. In addition, the electronic device 100 generates token information 630 for pairing with the wearable device 200, and generates a signal pattern 630-1 corresponding to the token information 630 generated. Each of the signal patterns is a binary signal pattern, and as illustrated in the drawing, the signal pattern 610-1 corresponding to the object 610 may be ‘01,’ and the signal pattern 620-1 corresponding to the address information 620 may be ‘01 011 100 . . . . ’ Further, the signal pattern 630-1 corresponding to the token information 630 for pairing with the wearable device 200 may be ‘1010.’

When signal patterns 610-1, 620-1, and 630-1 are determined, the electronic device 100 generates a frequency signal based on each signal pattern 610-1, 620-1, and 630-1. As illustrated in the drawing, the electronic device 100 may generate a frequency signal 610-2 of 100 KHz and 90 KHz based on the signal pattern 610-1 corresponding to the object 610, generate a frequency signal 620-2 of 90 KHz, 100 KHz, 90 KHz, 100 KHz, 100 KHz, 100 KHz, 90 KHz, 90 KHz . . . based on the signal pattern 620-1 corresponding to the address information 620 of the electronic device 100, and generate a frequency signal 630-2 of 100 KHz, 90 KHz, 100 KHz, and 90 KHz based on the signal pattern 630-1 corresponding to the token information 630.

When each of the frequency signals 610-2, 620-2, and 630-2 is generated, the electronic device 100 may generate an inductive current with a frequency component regarding each of the frequency signals 610-2, 620-2, and 630-2. In this case, the electronic device 100 may generate the inductive current which further includes an ACK signal for identifying whether each frequency component is started or finished. When such an inductive current is generated, the electronic device 100 transmits the inductive current to the wearable device 200, which a user is wearing, for example, on part of his or her body, through the user who touches the object 610. Accordingly, the wearable device 200 analyzes each frequency component included in the inductive current which is received through the user and transmits execution information including user information related to service information regarding the object selected by the user and token information for pairing with the electronic device 100 to the electronic device 100 through wireless communication. Accordingly, the electronic device 100 may execute a function corresponding to the object touched by the user based on the user information included in the execution information.

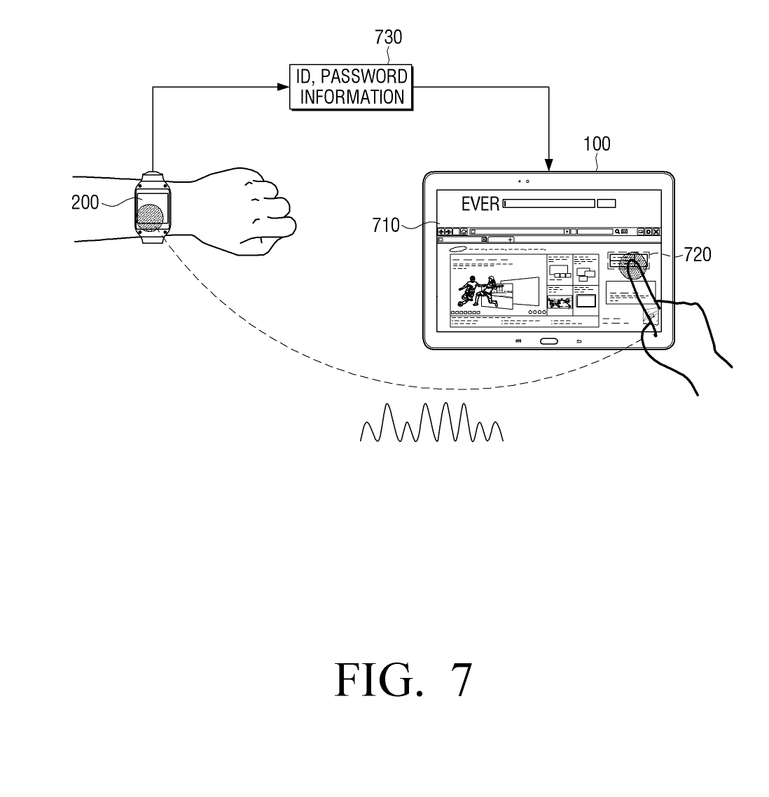

FIG. 7 is a first exemplary view where data communication is performed between an electronic device and a wearable device according to an exemplary embodiment.

As illustrated in FIG. 7, the electronic device 100 may display a web page screen 710 according to a user command. While the web page screen 710 is displayed, a user wearing the wearable device 200 may touch a log-in area 720 of the web page screen 710. When such a touch command is input, the electronic device 100 detects an object regarding the log-in area 720 corresponding to the user's touch command which is input, and acquires a predetermined identification code regarding the detected object and an identification code regarding address information of the electronic device 100. In addition, the electronic device 100 generates token information for pairing with the wearable device 200 and an identification code corresponding to the generated token information.

When such identification codes are acquired and generated, the electronic device 100 generates a frequency signal based on each identification code, generates an inductive current with a frequency component regarding each of the generated frequency signals, and transmits the inductive current to the wearable device 200 which a user wears on his or her wrist through the user who touches the object regarding the log-in area 720.

When the inductive current that has been generated is received from the electronic device 100 through the user, the wearable device 200 detects a signal pattern from each frequency component included in the inductive current received. Subsequently, the wearable device 200 analyzes each of the detected signal patterns and acquires service information regarding the object touched by the user, address information regarding the electronic device 100 and token information for pairing with the electronic device 100.

As described above, the object touched by the user is the log-in area 720 included in the web page screen 710 and thus, the wearable device 200 acquires user information 730 including user ID and password information corresponding to the service information regarding the log-in area 720 from among pre-stored user information. Subsequently, the wearable device 200 transmits the user information 730 including the user ID and password information which is pre-acquired based on the address information regarding the electronic device 100 and execution information including the token information to the electronic device 100 through a communication channel using a wireless communication method.

When such execution information is received, the electronic device 100 determines whether the token information included in the received execution information is identical to the token information transmitted to the wearable device 200 through the inductive current, and if it is determined that the two token information is identical, performs pairing with the wearable device 200. Subsequently, the electronic device 100 may perform log-in based on the user information 730 (the user ID and password information) included in the execution information.

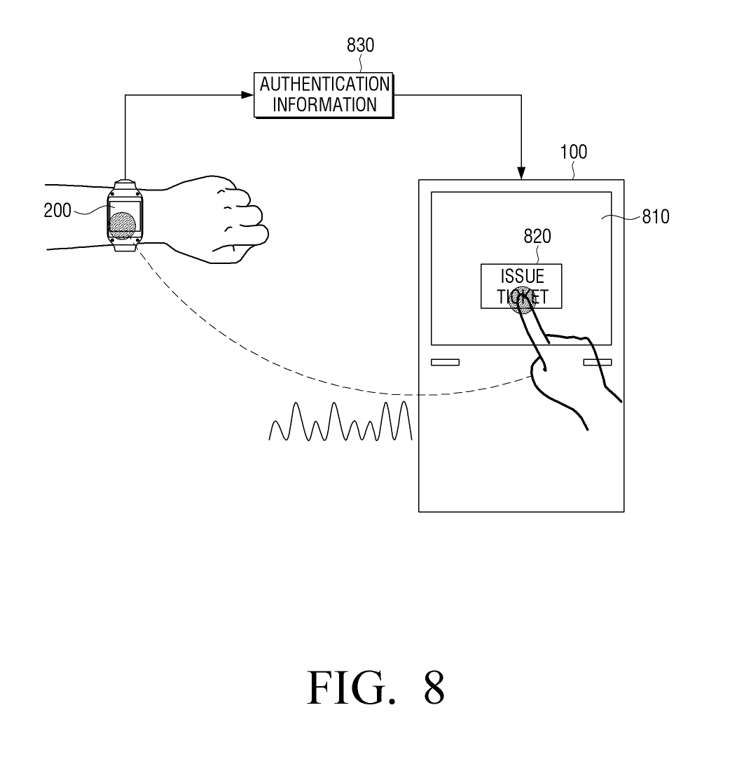

FIG. 8 is a second exemplary view where data communication is performed between the electronic device 100 and the wearable device 200 according to another exemplary embodiment.

As illustrated in FIG. 8, the electronic device 100 may be a kiosk. For example, a user may touch a ticketing UI 820 for issuing advance ticket for movie which is displayed on a display screen 810 of the electronic device 100, just like a kiosk in a theater for issuing advance ticket for movie. When such a touch command is input, the electronic device 100 detects an object regarding the ticketing UI 820 corresponding to the user's touch command which is input, and acquires a predetermined identification code regarding the detected object and an identification code regarding the address information of the electronic device 100. In addition, the electronic device 100 generates token information for pairing with the wearable device 200 which is wearable on a user's wrist, and generates an identification code corresponding to the generated token information.

When such identification codes are acquired and generated, the electronic device 100 generates a frequency signal based on each identification code, generates an inductive current with the frequency component regarding each of the frequency signals generated, and transmits the inductive current to the wearable device 200 which is worn on a user's wrist through the user who touches the object regarding the ticketing UI 820.

When the inductive current that has been generated is received from the electronic device 100 through the user, the wearable device 200 detects each signal pattern from the frequency component included in the inductive current received. Subsequently, the wearable device 200 acquires service information regarding the object touched by the user, address information regarding the electronic device 100 and token information for pairing with the electronic device 100 by analyzing each of the detected signal patterns.

As described above, the object touched by the user is the ticketing UI 820 for issuing advance ticket for movie, the wearable device 200 acquires authentication information 830 corresponding to the service information regarding the ticketing UI 820 from among pre-stored user information. Subsequently, the wearable device 200 transmits the authentication information which is pre-acquired based on the address information regarding the electronic device 100 and the execution information including the token information to the electronic device 100 through a communication channel using a wireless communication method.

When such execution information is received, the electronic device 100 determines whether the token information included in the received execution information is identical to the token information transmitted to the wearable device 200 through the inductive current, and if it is determined that the two information is identical, performs pairing with the wearable device 200. Subsequently, the electronic device 100 may output advance ticket for movie based on the authentication information 830 included in the execution information.

Meanwhile, the electronic device 100 may perform data communication with the wearable device 200 through a server 300. Hereinafter, the operation of performing data communication between the electronic device 100 and the wearable device 200 through the server 300 will be described in detail based on FIG. 8.

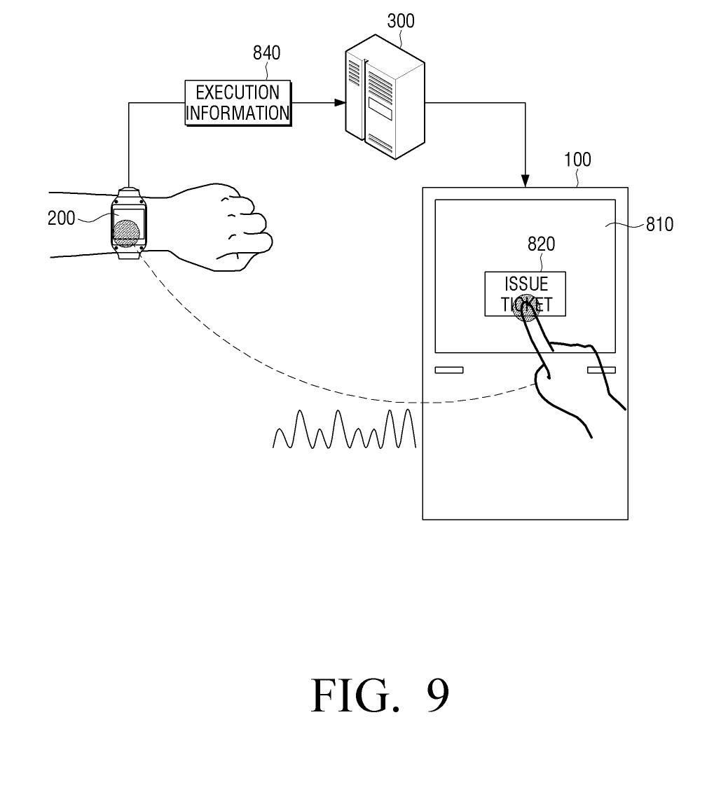

FIG. 9 is a third exemplary view where data communication is performed between an electronic device and a wearable device according to another exemplary embodiment.

As described above with reference to FIG. 8, the electronic device 100 may be a kiosk. For example, as illustrated in FIG. 9, a user may touch a ticketing UI 820 for issuing advance ticket for movie which is displayed on a display screen 810 of the electronic device 100, just like a kiosk in a theater for issuing advance ticket for movie. When such a touch command is input, the electronic device 100 detects an object regarding the ticketing UI 820 corresponding to the user's touch command which is input, and acquires a predetermined identification code regarding the detected object and an identification code regarding the address information of the electronic device 100.

When such identification codes are acquired, the electronic device 100 generates a frequency signal based on each identification code, generates an inductive current with a frequency component regarding each of the frequency signals generated, and transmits the inductive current to the wearable device 200 worn on a user's wrist through the user who touches the object regarding the ticketing UI 820.

When the inductive current that has been generated is received from the electronic device 100 through the user, the wearable device 200 detects each signal pattern from the frequency component included in the inductive current received. Subsequently, the wearable device 200 acquires service information regarding the object touched by the user and address information regarding the electronic device 100 by analyzing each of the detected signal patterns.

When such service information and address information regarding the electronic device 100 is acquired, the wearable device 200 acquires authentication for user authentication from among pre-stored user information based on pre-acquired service information. Subsequently, the wearable device 200 transmits execution information 840 including the pre-acquired authentication information and the address information regarding the electronic device 100 to the server 300. Here, the server 300 may be a business server capable of reserving movie ticket on-line.

When the execution information 840 is received from the wearable device 200, the server 300 performs user authentication based on the authentication information included in the received execution information 840. When the user authentication is completed, the server 300 transmits a control signal for outputting an authentication result UI to the electronic device 100 based on the address information included in the execution information 840. Accordingly, the electronic device 100 may display the authentication result UI on a screen based on the control signal received from the server 300.

For example, the authentication information may be user information such as a user's name and date of birth, and the user may reserve movie ticket on-line. In this case, the server 300 may store reservation information regarding the movie that the user requested and user information. Accordingly, the server 300 determines whether the reservation information regarding the movie requested by the user is pre-stored based on the authentication information included in the execution information 840. If it is determined that the reservation information regarding the movie requested by the user is pre-stored, the server 300 transmits a control signal for outputting an authentication result UI to the electronic device to the electronic device 100 based on the address information included in the execution information.

The electronic device 100 displays the authentication result UI for outputting advance ticket for movie on a screen according to the control signal received from the server 300. Subsequently, when a touch command regarding the displayed authentication result UI is input, the electronic device 100 may print out advance ticket for movie requested by the user.

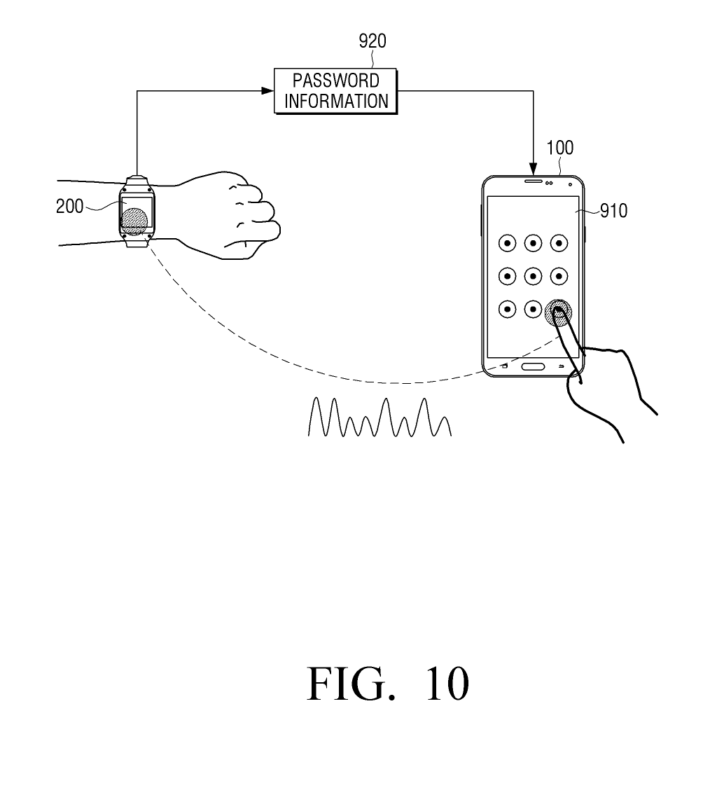

FIG. 10 is a fourth exemplary view where data communication is performed between an electronic device and a wearable device according to another exemplary embodiment.

As illustrated in FIG. 10, the electronic device 100 may be a smart phone or a tablet PC. The electronic device 100 may display a user authentication screen 901 for performing user authentication. While the user authentication screen 910 is displayed, a user wearing the wearable device 200 may touch a specific area of the user authentication screen 910. When such a touch command is input, the electronic device 100 determines that the display screen which is currently executed is the user authentication screen 910, and acquires a predetermined identification code regarding the user authentication screen 910 and an identification code regarding the address information of the electronic device 100. In addition, the electronic device 100 generates token information for pairing with the wearable device 200, and generates an identification code corresponding to the generated token information.

When such identification codes are acquired and generated, the electronic device 100 generates a frequency signal based on each identification code, generates an inductive current with a frequency component regarding each of the frequency signals generated, and transmits the inductive current to the wearable device 200 which is worn on a user's wrist through the user who touches the user authentication screen 910.

When the inductive current that has been generated is received from the electronic device 100 through the user, the wearable device 200 detects each signal pattern from the frequency component included in the inductive current received. Subsequently, the wearable device 200 acquires service information regarding the object touched by the user, address information regarding the electronic device 100 and token information for pairing with the electronic device 100 by analyzing each of the detected signal patterns.

As described above, the object touched by the user is the user authentication screen 910 and thus, the wearable device 200 acquires password information 920 for user authentication of the electronic device 100 from among pre-stored user information. Subsequently, the wearable device 200 transmits execution information including the password information 920 that has been acquired and the token information to the electronic device 100 through a communication channel using a wireless communication method based on the address information regarding the electronic device 100. Here, the password information 920 may be number information which is set by the user or connection pattern information between numbers.

When such execution information is received, the electronic device 100 determines whether the token information included in the received execution information is identical to the token information transmitted to the wearable device 200 through the inductive current, and if it is determined that the two information is identical, performs pairing with the wearable device 200. Subsequently, the electronic device 100 may perform user authentication based on the password information 920 included in the execution information and execute an application screen.

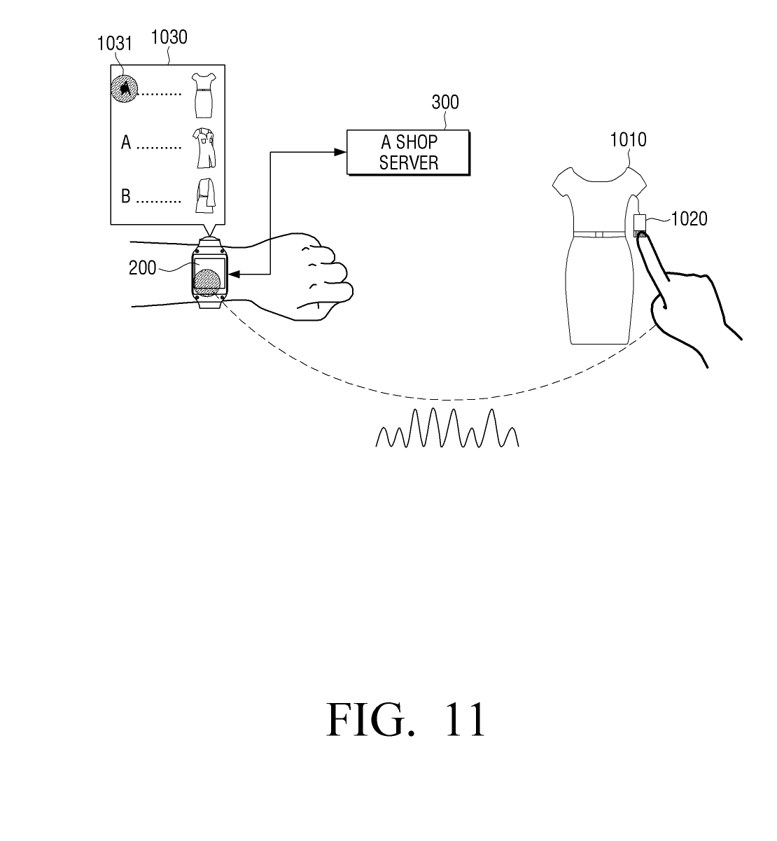

FIG. 11 is a fifth exemplary view where data communication is performed between an electronic device and a wearable device according to another exemplary embodiment.

As illustrated in FIG. 11, the electronic device 100 may be implemented as a label tag 1020 regarding clothes 1010 in a clothing shop. When a user touches the label tag 1020, which is attached to his or her clothes 1010, the label tag 1020 transmits an inductive current to the wearable device 200 which the user wears on the wrist through the user. Here, the inductive current may include a frequency component representing code information to identify the label tag 1020, a frequency component representing service information regarding the clothes 1010 and a frequency component representing address information regarding a shop server to provide detailed information regarding the clothes 1010.

When the inductive current generated is received from the label tag 1020 through the user, the wearable device 200 detects a signal pattern from each of the frequency components included in the inductive current received. Subsequently, the wearable device analyzes each of the detected signal patterns, matches the service information regarding the clothes touched by the user and the address information regarding the shop server and stores the matching information.

Subsequently, the wearable device 200 displays a wish list 1030 including pre-stored service information regarding each clothes on a screen according to a user command. Here, the service information may include at least one of a thumbnail image regarding the clothes selected by the user, stored date information, shop information and code information to identify clothes. If the user selects first user information 1031 while such wish list 1030 is displayed, the wearable device 200 may request detailed information regarding the clothes corresponding to the selected first user information 1031 to A shop server 400 based on the address information matched with the selected first user information 1031, and when the requested detailed information is received, display the received detailed information regarding the clothes corresponding to the first user information 1031 on a screen.

Hitherto, the operation of performing data communication between the electronic device 100 and the wearable device 200 has been described in detail through various exemplary embodiments. Hereinafter, the method of controlling the electronic device 100 and the wearable device 200 according to an exemplary embodiment will be described in detail.

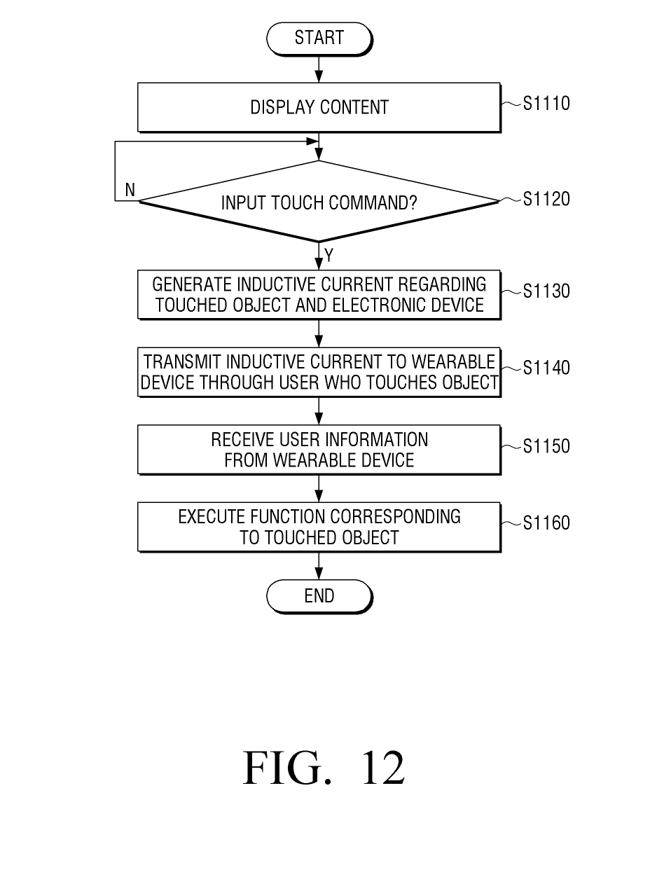

FIG. 12 is a flowchart regarding a method of controlling an electronic device according to an exemplary embodiment.

As illustrated in FIG. 12, the electronic device 100 displays a content requested by a user at block S1110. While such content is displayed, the electronic device 100 determines whether a touch command regarding at least one object included in the displayed content is input at block S1120. If it is determined that a touch command regarding at least one object is input, the electronic device 100 generates an inductive current based on a signal pattern corresponding to the object for which the touch command is input and the electronic device 100 at block S1130. Here, the inductive current may be micro-current including a frequency component.

Specifically, when on object corresponding to the touch command is detected, the electronic device 100 acquires a signal pattern corresponding to the pre-detected object and a signal pattern corresponding to the address information of the electronic device from among pre-stored signal patterns. Subsequently, the electronic device 100 generates an inductive current with a frequency component corresponding to each of the acquired signal patterns. In this case, the electronic device 100 may generate a signal pattern for pairing with the wearable device 200, and generate an inductive current with a frequency component corresponding to the signal pattern for pairing.

When such an inductive current is generated, the electronic device 100 transmits the inductive current to the wearable device 200 through the user who touches the object at block S1140.

Meanwhile, if execution information including user information is received from the wearable device 200 which transmits the inductive current, the electronic device 100 executes a function corresponding to the object touched by the user based on the user information received at block S1150. Specifically, the execution information received from the wearable device 200 which transmits the inductive current may include user information for executing the object touched by the user and token information for pairing with the wearable device 200.

Accordingly, if the token information included in the received execution information is identical to the token information which is transmitted to the wearable device 200 through the inductive current, the electronic device 100 performs pairing with the wearable device 200. Subsequently, the electronic device 100 may perform the function corresponding to the object touched by the user based on the user information included in the execution information.

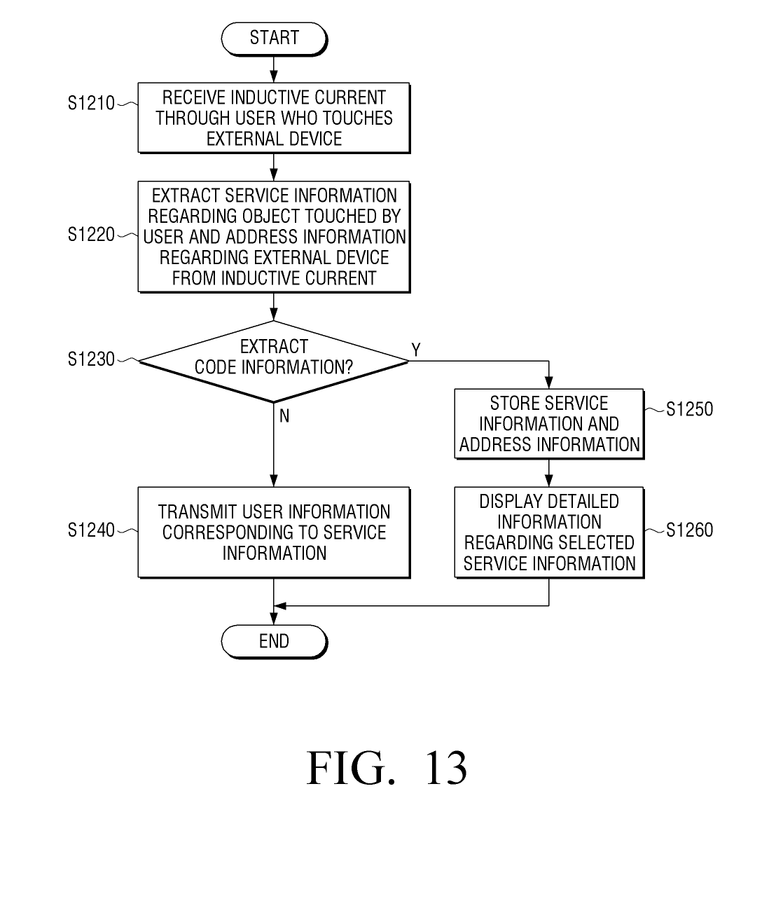

FIG. 13 is a flowchart regarding a method of controlling a wearable device according to an exemplary embodiment.

As illustrated in FIG. 13, the wearable device 200 receives the inductive current that has been generated from the electronic device 100 through the user who touches a display screen (e.g., the display screen 122 of FIG. 1) of an external device (hereinafter, referred to as an electronic device) at block S1210. Here, the inductive current may be a micro-current signal including a frequency component. When such an inductive current is received, the wearable device 200 analyzes the inductive current received to extract service information regarding the object touched by the user from among objects displayed on the display screen and address information regarding the electronic device at block S1220.

Specifically, the wearable device 200 detects a signal pattern from the frequency component included in the inductive current. Subsequently, the wearable device 200 may acquire service information regarding the object touched by the user and address information regarding the electronic device 100 by analyzing the detected signal pattern.

Meanwhile, the wearable device 200 determines whether predefined code information is further extracted from the inductive current received at block S1230. If it is determined that pre-stored code information is not extracted, the electronic device 100 transmits user information corresponding to the service information to the electronic device 100 based on the address information of the electronic device 100 at block S1240.

Meanwhile, in block S1220, the wearable device 200 may further extract token information for pairing with the electronic device 100 from the signal pattern which is detected from a frequency component included in the inductive current received. When such token information is extracted, the wearable device 200 transmits execution information including user information corresponding to the pre-acquired service information and the token information for pairing with the electronic device 100 to the electronic device based on the address information.

Accordingly, if the token information included in the received execution information is identical to the token information which is transmitted to the wearable device 200 through the inductive current, the electronic device 100 performs pairing with the wearable device 200. Subsequently, the electronic device 100 may perform a function corresponding to the object which is touched by the user based on the user information included in the execution information.

Meanwhile, if pre-defined code information is extracted from the inductive current received in block S1230, the wearable device 200 matches service information regarding the object touched by the user and address information related to the electronic device 100 or a server which will provide detailed information regarding the corresponding object and stores the matching information at block S1250. Subsequently, if a selection command with respect to service information regarding at least one object from among a plurality of pieces of pre-stored service information for each object is input, the wearable device 200 receives detailed information regarding the corresponding object from the electronic device 100 or the server based on the address information which is matched with respect to the service information for which the selection command is input and displays the received detailed information on a screen at block S1260.

Hereinafter, the method of performing data communication between the electronic device 100 and the wearable device 200 through the server 300 will be described in detail.

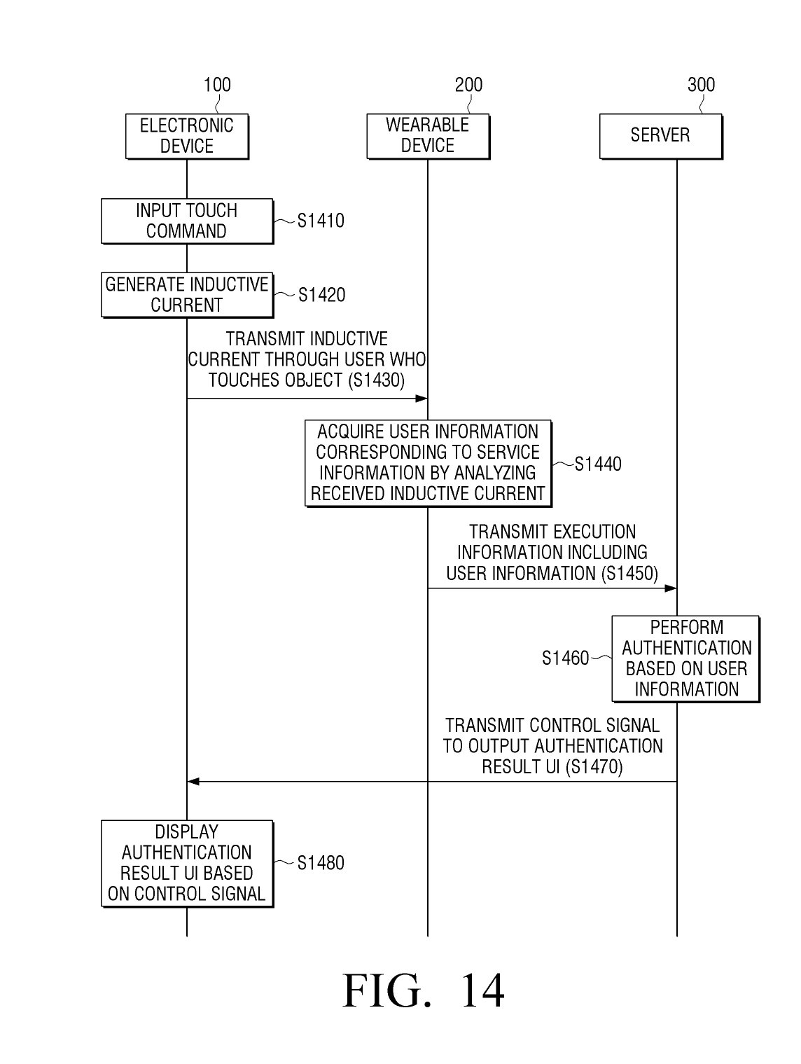

FIG. 14 is a process view where data communication between an electronic device and a wearable device is performed through a server according to another exemplary embodiment.

As illustrated in FIG. 14, if a touch command regarding at least one object displayed on the display screen 810 is input, the electronic device 100 generates an inductive current with a frequency component regarding the at least one object which is touched by the user on the display screen at blocks S1410, S1420.

Specifically, if an object corresponding to the touch command input by the user is detected, the electronic device 100 acquires a predetermined identification code regarding the detected object and an identification code regarding the address information of the electronic device 100. Subsequently, the electronic device 100 generates a frequency signal based on each of the identification codes and generates an inductive current with a frequency component regarding each of the generated frequency signals. When such an inductive current is generated, the electronic device 100 transmits the corresponding object to the wearable device 200 which is worn on the user's wrist through the user who touches the corresponding object at block S1430.

When the inductive current that has been generated is received from the electronic device 100 through the user, the wearable device 200 detects a signal pattern from each of the frequency components included in the inductive current received. Subsequently, the wearable device 200 acquires service information regarding the object touched by the user and address information regarding the electronic device 100 by analyzing each of the detected signal patterns at block S1440.

When such service information and address information regarding the electronic device 100 is acquired, the wearable device 200 acquires authentication information for user authentication from among pre-stored user information based on the pre-acquired service information. Subsequently, the wearable device 200 transmits execution information including the pre-acquired authentication information and the address information regarding the electronic device 100 to the server 300 at block S1450.

When the execution information is received from the wearable device 200, the server 300 performs user authentication based on the authentication information included in the received execution information at block S1460. When the user authentication is completed, the server 300 transmits a control signal for outputting an authentication result UI to the electronic device 100 based on the address information included in the execution information at block S1470. Accordingly, the electronic device 100 displays the authentication result UI on a screen based on the control signal received from the server 300 at block S1480.

Hitherto, the present disclosure has been described based on exemplary embodiments.

The foregoing embodiments and advantages are merely exemplary and are not to be construed as limiting the present embodiment. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

The electronic device, a wearable device, and a controlling method according to various exemplary embodiments described above may be implemented in a program so as to be provided to the display apparatus. Particularly, the program including the portable terminal apparatus and control method may be stored and provided in a non-transitory computer readable medium.

The non-transitory computer readable medium does not mean a medium storing data for a short period such as a register, a cash, a memory, or the like, but means a machine-readable medium semi-permanently storing the data. Specifically, various applications or programs described above may be stored and provided in the non-transitory computer readable medium such as a compact disc (CD), a digital versatile disk (DVD), a hard disk, a Blu-ray disk, a universal serial bus (USB), a memory card, a read-only memory (ROM), or the like.

What is claimed is:

1. A method of controlling an electronic device, the method comprising:
receiving a touch command with respect to an object displayed on a display screen;
generating an inductive current based on a signal pattern corresponding each of the object for which the touch command is input and the electronic device; and
transmitting the inductive current that has been generated to a wearable device through a user who touches the object displayed.

2. The method as claimed in claim 1, wherein the inductive current is a micro-current signal with a frequency component.

3. The method as claimed in claim 1, wherein the generating comprises, in response to the object corresponding to the touch command being detected, acquiring a signal pattern corresponding to the object detected and a signal pattern corresponding to address information of the electronic device from among pre-stored signal patterns, and generating the inductive current with a frequency component corresponding to the signal patterns acquired.

4. The method as claimed in claim 3, wherein the generating comprises generating a signal pattern corresponding to token information for pairing with the wearable device, and generating the inductive current with a frequency component corresponding to the signal pattern generated.

5. The method as claimed in claim 1, further comprising:
in response to user information being received from the wearable device, executing a function corresponding to the object touched based on the user information received.

6. A method of controlling a wearable device, the method comprising:
receiving an inductive current generated from an external device through a user who touches a display screen of the external device;
extracting service information regarding an object touched by the user from among objects displayed on the display screen and address information regarding the external device by analyzing the inductive current received; and
transmitting user information corresponding to the service information to the external device based on the address information.

7. The method as claimed in claim 6, wherein the inductive current is a micro-current signal with a frequency component.

8. The method as claimed in claim 7, wherein the extracting comprises detecting a signal pattern from the frequency component included in the inductive current, and extracting service information regarding the object touched and address information regarding the external device by analyzing the signal pattern detected.

9. The method as claimed in claim 8, wherein the extracting comprises further extracting token information for pairing with the external device from the signal pattern detected from the frequency component included in the inductive current,
wherein the transmitting comprises transmitting user information included in the token information to the external device.

10. The method as claimed in claim 8, further comprising:
in response to predefined code information being extracted from the signal pattern detected, storing the service information and the address information regarding the object touched; and
in response to service information being selected from among a plurality of pieces of pre-stored service information, displaying information regarding the object based on address information which is associated with the service information and pre-stored.

11. An electronic device, comprising:
a touch input unit configured to receive a touch command with respect to an object displayed on a display screen; and
a controller configured to generate an inductive current based on a signal pattern corresponding to the object for which the touch command is received and the electronic device,
wherein the inductive current is transmitted to a wearable device through a user who touches the object.

12. The electronic device as claimed in claim 11, wherein the inductive current is a micro-current signal with a frequency component.

13. The electronic device as claimed in claim 11, wherein the controller, in response to the object corresponding to the touch command being detected, acquires a signal pattern corresponding to the object detected and a signal pattern corresponding to address information of the electronic device from among pre-stored signal patterns, and generates the inductive current with a frequency component corresponding to the signal patterns acquired.

14. The electronic device as claimed in claim 13, wherein the controller generates the signal pattern for pairing with the wearable device, and generates the inductive current with the frequency component corresponding to the signal pattern generated for pairing.

15. The electronic device as claimed in claim 11, further comprising:
a communicator,
wherein the controller, in response to user information being received from the wearable device, executes a function corresponding to the touched object based on the user information received.
